(19) United States
(12) Patent Application Publication
(10) Pub. No.: US 2010/0122643 A1
(43) Pub. Date: May 20, 2010

(54) Modular grate block for a refuse incinerator

(76) Inventors: Arthur W. Cole, Hampton, NH (US); John E. Cannon, Chester, NH (US)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 12/313,429

(22) Filed: Nov. 20, 2008

(51) Int. Cl. F23H 3/00; B23P 19/04

(52) U.S. Cl. 110/298; 29/700

(57) ABSTRACT

An improved modular grate block for an incinerator having a removable wear plate that can be replaced without removing individual grate blocks from a plurality of rows of fixed and movable grate blocks.

### BACKGROUND OF THE INVENTION

This invention relates to grate blocks, which are a key feature of modern waste to energy plants that incinerate refuse and capture the energy released as steam for generating electricity. As a result of changes in the composition of refuse or garbage, and particularly due to the increase in caloric value of such material, the combustion grate, which is made up of a plurality of individual grate blocks, is exposed to high thermal stresses, particularly certain individual portions thereof such as the front face of the individual grates. Furthermore, the operator of municipal waste mass burning applications typically has no control over the composition of the trash being fed into the system. At any given moment, one section of the grate can have a pile of wet yard waste while another section can have bags of high caloric or energy content plastic containers.

Due to the dual function of the combustion grate as a combustion support with ventilating means and also as a transfer or conveyance means for the material to be burned, the grate structure often includes such features as alternating fixed and movable grate sections and is a relatively complex multi-part structure. By having a uniform distribution of air beneath the grate, the basic design and operation ensures adequate oxygen for good combustion and cooling. The grate area and length is selected for sufficient residence time to allow for complete burnout, generally less than 2 percent unburned carbon content remains in the ash residue.

There are numerous factors in the combustion process that are monitored and/or attempted to be controlled. One such factor or boundary condition that is attempted to be controlled is the grate temperature. The specific control intervention involves establishing combustion temperature controls such that the average temperature of the grate layer does not exceed 300° C. with a combustion temperature of, for example, 1000° C. Local overheating of the grate layer due to heat accumulation leads to increased corrosion and an increased scale formation rate. This results in excess wear of parts of the grate within a relatively short time and extensive annual maintenance. In these annual maintenance periods, large segments of grate parts are replaced.

The prior art has recognized one preventative measure for preventing high corrosion or scaling rates and the resulting increased mechanical wear which leads to the premature destruction of larger segments of grate block is provided by cooling off the grate blocks. There are several techniques for cooling including passing a coolant such as water through a chamber in the grate blocks and forcing air through the grate blocks. Generally, when cooling air is used, the cooling air is additionally used as the primary combustion air. Thus, the control of the primary combustion air is also a temperature control measure. For forced cooling purposes, the under grate blast generally flows against the grate layer first and air passage openings in the layer, which allows the cooling medium to pass into the refuse bed to be burned where it then participates in the combustion process as the primary combustion air. Clogging of the air openings, however, leads to reduced flow and increased back pressure in the cooling air path and, consequently, to accumulation of heat at the particular point of the grate layer. This leads to thermal overstressing of the grate part, increased wear, higher scaling rates and, within a short time, the failure of portions of the grate.

Our invention solves the above-stated problems by providing an improved modular grate block that has at least one wear plate attached to the front face of the grate block. This wear plate is designed to be removed and replaced with a new wear plate and thus avoiding the cost and waste associated with replacing the entire grate block.

### SUMMARY OF THE INVENTION

Our invention eliminates the wasteful and expensive practice of discarding individual grate blocks that are worn from the high temperatures and corrosive environments found in refuse incinerators. More specifically, our invention is directed to providing individual modular grate blocks that have at least one wear plate, which is preferably attached to the front face of the grate block. The grate system of our invention preferably has a plurality of rows of fixed grate blocks and a plurality of rows of movable grate blocks alternating back and forth with each individual block having a removable wear plate as described in more detail below. A reciprocal mechanism is connected to each of the rows of moveable grate blocks for moving the rows relative to the rows of the fixed grate blocks. Each of the modular grate blocks has a top section, a front face, and a pair of side walls. Each side wall extends from the top section and the front wall. Each of the side walls of the grate blocks engage the side wall of the adjacent grate block. Although it is preferred that the at least one wear plate is attached to the front face, it is within the scope of our invention to have a wear plate attached to the top section. Each grate block has a paw portion located at the lower surface of the side section wall and front face. In a preferred embodiment, the wear block extends below the paw and engages a top section of a grate block directly in front and underneath.

The wear plate our invention is preferably made of a material that is different than the material used to fabricate the grate block body. In particular, it is preferred that the wear plate comprise a harder material and more corrosion resistant than the block body. Although harder or hardened materials are typically heavier and have higher costs associated therewith, these negatives are minimized because only the wear plate is made of such hardened materials. Indeed, it would be cost prohibiting to fabricate the unitary prior art blocks from hardened materials. With regard to the wear plates of our invention the preferred materials of construction that resist wear and corrosion include chrome-nickel alloys, stainless steels, ceramics, titanium and like materials.

Another feature of the modular grate blocks of our invention is the removability of the wear plates, especially when worn wear plates must be replaced with new wear plates. Although this removability feature can be accomplished by any known connection method, it is preferred to use a press fit connection between the backside of the wear plate and the front surface of the face wall of the grate block. One type of press fit connection that is particularly preferred is where a male protrusion or nub on the wear plate engages a corresponding slot in the front wall of the block body. Preferably, the dimensions of the nub and slot are chosen such that nub is held in the slot by friction, thus preventing the wear plate from moving in either a vertical or horizontal manner. A most preferred configuration is where the nub slides into a cup shaped slot that is tapered to provide the friction press fit. Alternatively, the nub and slot could form a “dovetail” type joint or connection.

The wear plate can be fabricated to match exactly the dimensions of the front wall of the grate block or it can be smaller or larger than the front surface of the front wall. Preferably, the wear plate should match the side walls and the top wall, but extend beyond the paw or lower edge of the front face. In this manner the wear plate becomes the bearing surface for contacting the top surface of the grate block positioned in front and underneath. This will prevent the paw of the grate block from wearing because the bottom of the wear plate makes the contact with the top wall of the grate block disposed beneath.

Our invention also encompasses methods for retrofitting an existing incinerator grate system where prior art grate blocks, which do not have wear plates, are inspected, identified as being worn, and then removed and replaced with the grate blocks of our invention that have at least one wear plate. Alternatively, the entire grate system can be changed out with a system having the modular grate blocks of our invention. In addition, our invention is directed to a method where an incinerator grate block system is inspected to identify blocks having worn wear plates and then replacing those worn wear plates with new wear plates without having to remove the individual grate blocks. Basically, the method involves locating worn wear plates, popping off the worn wear plate and snapping on a new wear plate, while leaving the grate block body attached to the system. This method of repair is cost effective in that labor is greatly reduced as well as the cost of the wear plate compared to the cost of replacing the entire grate block. Moreover, the incinerator downtime is greatly reduced as is the frequency of the planned maintenance because the wear plate can be fabricated with a longer lasting material of construction.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic of a combustion furnace;

FIG. 2 is a perspective view of a portion of the grate blocks with a portion of the grate blocks removed;

FIG. 3 is a partial side elevation, in partial section, illustrating grate blocks in accordance with the invention assembled in a grate layer;

FIG. 4 is a partial perspective side and top view of the front portion of a grate block of our invention having attached a wear plate;

FIG. 5 a partial perspective side and bottom view of the front portion of a grate block of our invention having attached a wear plate;

FIG. 6 is a partial perspective side and bottom view of the front portion of a grate block of our invention showing the wear plate removed from the front wall and showing the nub and slot connection;

FIG. 7 is a partial perspective side and top view of the front portion of an alternative grate block of our invention having attached a wear plate;

FIG. 8 a partial perspective side and bottom view of the front portion of an alternative grate block of our invention having attached a wear plate;

FIG. 9 is a partial perspective side and bottom view of the front portion of an alternative grate block of our invention showing the wear plate removed from the front wall and showing an alternative nub and slot connection;

### DETAILED DESCRIPTION OF THE INVENTION

Referring to the drawings in detail, there is illustrated a a grate block in accordance with the present invention designated generally as 40. In a preferred embodiment, the grate block according to the invention is a modular block with at least one removable wear plate. The overall design of the complete grate block is to direct air flow to allow for generally uniform burning of trash or refuse without thermal stress caused by intense combustion and cooling.

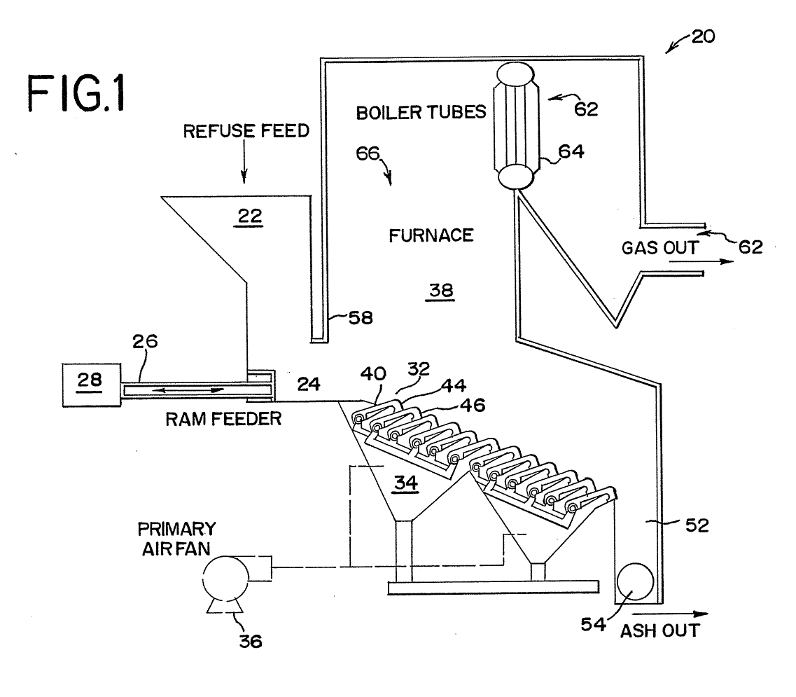

Referring to FIG. 1, one possible design of a combustion furnace 20 has trash, also referred to as refuse or fuel, fed via a refuse feed chute 22. The trash is typically not homogeneous and can include wet yard waste, non-combustible material, and high energy content or caloric material. The trash drops upon a feed table 24, on which a pusher ram 26 is moved back and forth by a drive 28. The feed table 24 is adjoined at the same height by the start of a grate 32 having a plurality of grate blocks 40 which consists of fixed rows 44 arranged stepwise and movable rows 46 arranged in-between the fixed rows 44. The movable rows 46 are shown in FIG. 1 in a center position, in which the movable rows 46 are positioned over the fixed rows 44 arranged below them in between a retracted position and an extended position.

Underlying the grates 32 are a plurality of hoppers 34. Each of the hoppers 34 is capable of gathering any trash or ash that falls through the grate 32. It is not typical for large amounts of trash or ash to fall through the grate 32 unless one of the grate blocks 40 fails. In addition, each of the hoppers 34 is connected to an air source, such as a primary air fan 36 as seen in FIG. 1. The air from the air source passes through openings in the grate block 40, as described below, to a combustion chamber 38. FIG. 1 shows two hoppers 34, but the combustion furnace 20 typically has as many as four hoppers 34 in a trash conveying direction. Depending on the width of the combustion furnace, the furnace can typically have 1 to 6 hoppers in the direction perpendicular to the conveying direction. By means of a back and forth movement of the movable rows 46, the trash, i.e., the fuel, is moved slopingly downwards on the grate 42 until it drops, completely burned, into an ash receiver 52, from which the ash is transported away, for example, by means of a conveyor 54.

The movement of the movable rows 46 is accomplished by hydraulics or a motor driven actuator. The movable rows 46 over each hopper 34 are controlled as a unit and the units can each be controlled individually. The combustion furnace 20 can have the rate of movement of each section or unit of movable rows 46 be at a different rate. The combustion furnace 20 has the combustion chamber 38 arranged above the grate 42. The combustion chamber 38, on the left side of FIG. 1, towards the tray 24 and the pusher tray ram 26 is defined by a wall 58 which starts slightly above the start of the grate. The combustion gases reach an exit 60 of the combustion furnace 20 through a passage 62. Heat exchangers, such as the boiler tubes 64 as shown in FIG. 1, filters, and the like can adjoin the exit 18 of the boiler. The grate according to the present invention is designed such that the combustion takes place with primary air passing through the grate blocks 40 from the hoppers 34.. Secondary air is admitted to the combustion chamber 38 above the grate 32 and the trash through the upper portion of the chamber such as represented by an arrow 66.

The combustion furnace 20 with the grate block 40 arrangement as described above operates with combustion air which passes through openings in the grate blocks 40. The combustion chamber 38 is under reduced pressure which causes combustion air from the hopper, which is under positive pressure by the primary air fan 36, to be forced through the openings 120 in the grate blocks 40 as seen in FIGS. 4 & 7. Sharply defined combustion conditions can be set by means of proper air distribution. For example, the combustion chamber 38 can be operated at −0.1 inches of pressure, which maintains a negative pressure that prevents smoke and exhaust from entering the building through penetration and openings in the combustion furnace and the hopper 22. The combustion furnace 20, can preferably be designed with an after-burning chamber in which very high temperatures decompose any unburned pollutants thermally to produce harmless gases and are generated as a result of radiant heat and good insulation. The combustion furnace 20 can also operate without an additional flame, due to the controlled trash feed and transport on the grate; the trash rate can be reliably controlled at any time, so that defined temperatures and combustion conditions can be achieved even with trash having widely varying properties. However, it is typical to have starter burners in order to have the combustion chamber 38 reach sufficient temperature prior to the introduction of trash for environmental reasons.

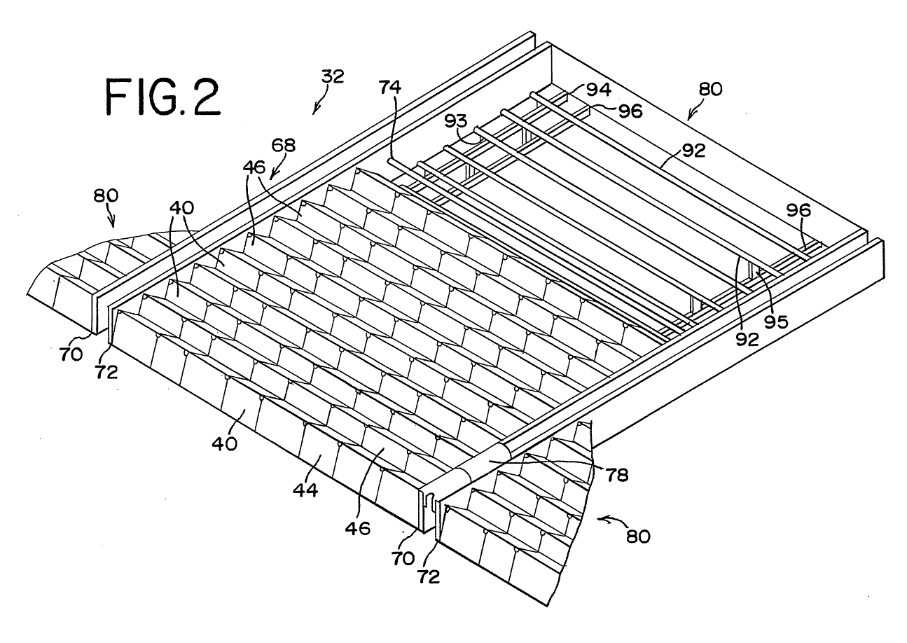

The basic structure of the trash combustion grate 32 of this invention with its essential elements is shown most clearly in FIG. 2. FIG. 2 shows a portion of the grate 32 in a perspective view, with some of the grate blocks 40 removed. The grate 32 is sloped downwards in the direction of the conveyance, as represented by an arrow 68. The grate 32 can be formed of several modules 80 in the direction perpendicular to the conveying direction, wherein each module overlies a hopper. Each module 80 has a pair of side wall blocks 70 and 72 that are stably connected to each other by a plurality of tensioning rods 74. These tensioning rods 74 extend perpendicular and extend across the inside width between the pair of side wall blocks 70 and 72. The tensioning rods 74 are threaded at each end and extend through openings in the pair of side wall blocks 70 and 72. The tensioning rods 74 are secured to the pair of side wall blocks 70 and 72 by a plurality of nuts on the threaded ends. The tensioning rods 74 also serve as supporting rods for the group of stationary grate blocks 40 that receive the rod 74 through a support rib. A shorter tensioning rod extends through the grate blocks 40 of the movable row 46. A movable row 46 of grate blocks 40, moving in the direction opposite the conveyance, is located on the first fixed row 44. The front under edge of grate blocks 40 of the movable row 46 rests on the grate blocks 40 of the first fixed row 44 below. The front under edge of the next highest fixed row 44 rests in turn on the movable grate blocks 40 and so on. While the grate 32 is shown having a slope, such that there is a change in vertical height from one end to the other of the grate, it is recognized that the slope can be horizontal (i.e., having no slope).

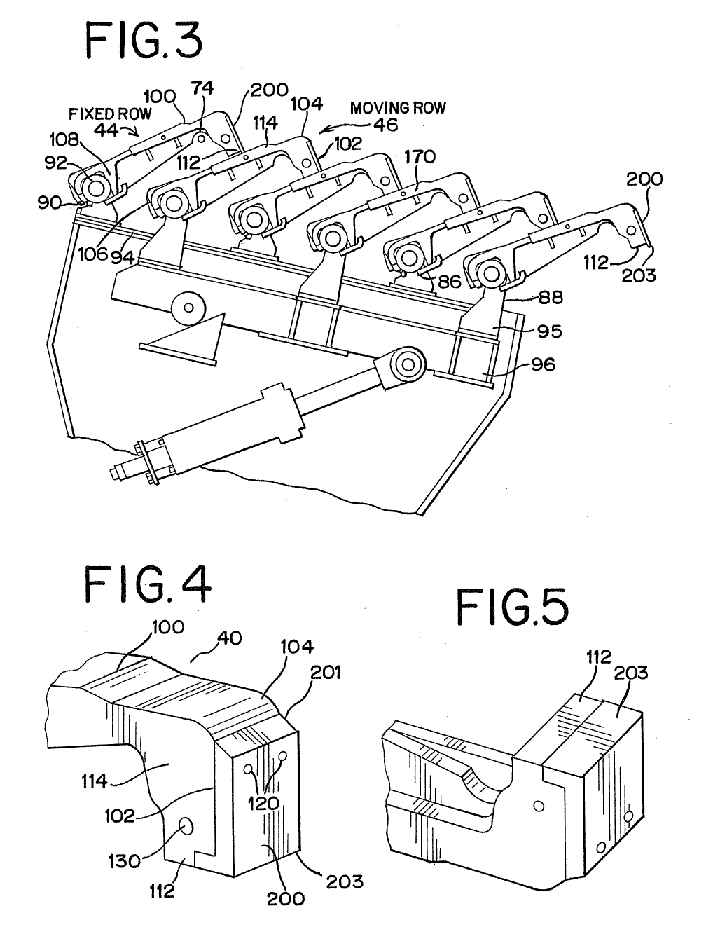

The grate blocks 40 for both the moveable rows 46 and the fixed rows 44 have a hook portion at the rear of the block that are each received by a respective block holding tube 92. The block holding tube 92 for the fixed rows 44 are each supported by at least a pair of support ribs 93. Each support rib 93 is carried by a support rail 94 as seen in FIG. 2 that extends parallel with the conveyance direction. Likewise the block holding tube 92 for the movable rows 46 are each supported by support ribs 95 and a carriage rail 96. The block holding tube 92, the support ribs 93 and 95 and the rails 94 and 96 are shown in further detail in FIG. 3.

As indicated above with respect to FIG. 1, the area underneath the grate 32 has a plurality of hoppers 34. These hoppers define several distinct zones as represented by the grate modules 80. In addition to being able to vary the stroke rate of the movable rows 46, the hoppers are distinct in that the air flow underneath the grate can be adjusted to each region defined by the hoppers 34. Primary air is blown into the individual zones by means of the primary air fan 36 with adjustable dampers, and this air then reaches the combustion chamber through the openings in the grate block 40. As further illustrated in FIG. 3, the combustion furnace 20 has the plurality of block holding tubes 92. The block holding tubes 92 for the fixed rows 44 are each supported by the support ribs 93 carried by the support rail 94. The block holding tubes 92 for the movable rows 46 are each supported by the support ribs 95 carried by the carriage rail 96. The grate blocks 40 are mounted on bearing means 92 which are supported on supports 94 and 96, and the blocks 40 being rotatable relative to the block holding tube 92.

As indicated with respect to FIG. 2, the movable rows 46 can be adjusted in stroke rate by the movement of the carriage rail 96 by the actuator 92. The tensioning rods 74 are provided to support the blocks 40 and are coupled together so that the blocks are movable in groups and are combined together perpendicular to the longitudinal direction or the direction of conveyance of the grate assembly 32.

Referring to FIG. 3, the grate block 40 has an top wall 100, a front wall 102, and can have an angle corner wall 104, which is interposed between the top wall 100 and the front wall 102. In addition, the grate block has a projecting arm 106 that extends under the overlying grate block 40. The arm has a hook 108 that receives the support rod 92. The top wall 100 has a thickened portion 110 on which a paw 112 of the front wall 102 of the block above moves relative to the lower block. The grate block 40 also has a pair of side walls 114. The projecting arm 106 has the hook 108 for receiving the support rod 92. The top wall 100 has a thickened portion 110 upon which the paw 112 of the overlaying grate block 40 rests. The side wall 114 has an alignment pin hole 130 for accepting an alignment pin for securing adjacent grate blocks together. Front wall 102 has attached wear plate 200 each with a bottom edge 203.

FIGS. 4-6 and FIGS. 7-9 show two of the many possible configurations of wear plates 200 removably attached to front wall 102 of grate block body 40. As mentioned, it is also within the scope of our invention to have wear plates attached to the top wall of the grate block. In both embodiments shown in the figures the wear plate extends down below the bottom edge of paw 112 to act as a bearing surface for contact on the top wall of another grate block in the system as shown in FIGS. 2 & 3. Because bottom edge 203 of wear plate 200 is the only portion of the grate block in contact with the top wall of the other grate block, this prevents wear to paw 112. This is clearly shown in FIGS. 5 & 8 where when viewed from the underneath side of grate block 40, lower edge 203 of wear plate 200 extends beyond the bottom edge of paw 112.

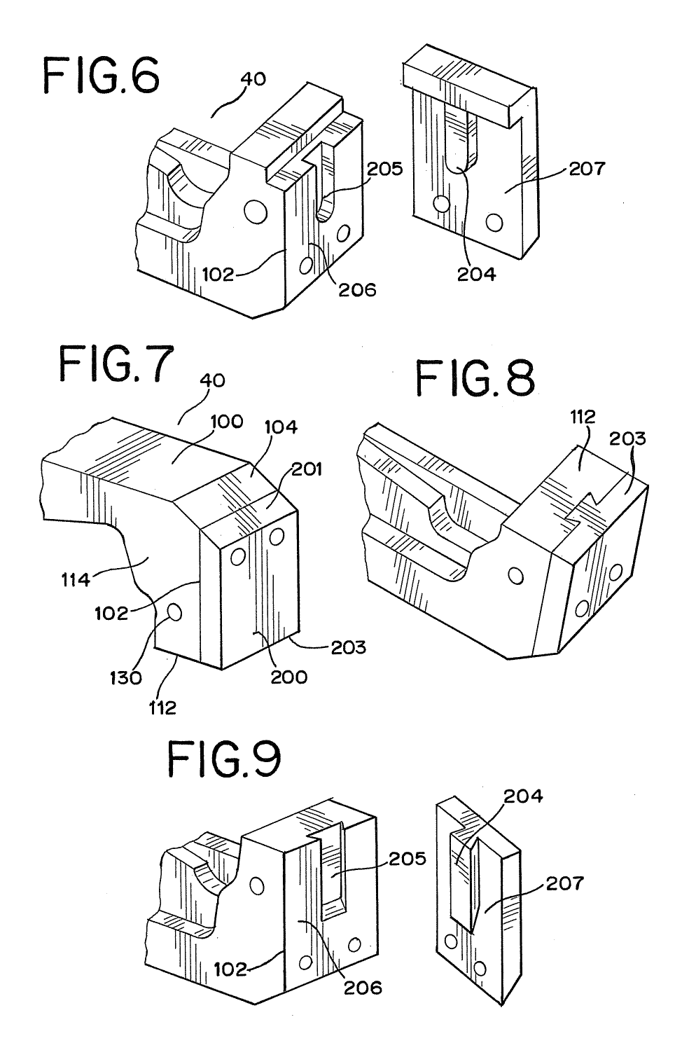

Top edge 201 of wear plate 200 is shown matching the angle of inclination defined by corner wall 104 of top wall 100, however, other designs where the angle is not matched are possible. Wear plate 200 also has holes 120 to allow combustion air to flow from underneath grate block 40. This flow of combustion air not only supplies the oxygen necessary for combustion, but also acts a heat transfer medium to cool the grate block and attached wear plate. FIGS. 6 & 9 illustrate two possible connection designs to removably secure backside 207 of wear plate 200 to front surface 206 of grate block 40. As mentioned, any connection design can be used to secure the wear plate to the front wall of the block body, provided that it is not a permanent connection. It is important that the connection between the wear plate and the grate block is releasable so that during a shutdown of the incinerator a maintenance worker can replace a worn wear plate with a new wear plate without removing individual grate blocks from the system.

The means, materials, and steps for carrying out various disclosed functions may take a variety of alternative forms without departing from the invention. Thus, the expressions “means to . . . ” and “means for . . . ”, or any method step language as may be found in the specification above or the claims below, followed by a functional statement, are intended to define and cover whatever structural, physical, chemical or electrical element or structure, or whatever method step, which may now or in the future exist which carries out the recited function, whether or not precisely equivalent to the embodiment or embodiments disclosed in the specification above, i.e., other means or steps for carrying out the same function can be used; and it is intended that such expressions be given their broadest interpretation within the terms of the following claims. Likewise, the claims should not be read as limited to the described order or elements unless stated to that effect. Therefore, all embodiments that come within the scope and spirit of the following claims and equivalents thereto are claimed as the invention.

We claim:

1. A modular grate block for use in a grate system within an incinerator, comprising:
a) an top wall having a top surface;
b) a front wall having a front surface extending from the top surface and terminating in a paw;
c) a pair of side walls each having an outer surface for engaging adjacent grate blocks and an inner surface, the side walls parallel to each other and spaced from each other, each outer side surface extending from the top surface and the front surface; and
d) at least one wear plate removably attached to the front surface.

2. The grate block of claim 1 wherein the wear plate extends below the paw of the front wall.

3. The grate block of claim 1 wherein the top surface joins the front surface at angle greater than 90 degrees.

4. The grate block of claim 3 wherein the wear plate has a top edge that matches the angle of the top surface of the top wall.

5. The grate block of claim 1 wherein the wear plate is connected to the front surface using a press fit.

6. The grate block of claim 1 wherein the wear plate has a raised nib that engages a correspondingly shaped slot in the front surface.

7. The grate block of claim 6 wherein the engagement between the nib and slot is a removable press fit.

8. The grate block of claim 1 wherein the wear plate is formed of a different metal than that of the top, front and side walls.

8. The grate block of claim 8 wherein the wear plate comprises a chrome nickel alloy.

9. A method of retrofitting a refuse incinerator grate system comprising:
a) shutting down the incinerator;
b) inspecting the grate block system and identifying worn grate blocks;
c) replacing worn grate blocks with modular grate blocks comprising,
i. an top wall having a top surface;
ii. a front wall having a front surface extending from the top surface and terminating in a paw;
iii. a pair of side walls each having an outer surface for engaging adjacent grate blocks and an inner surface, the side walls parallel to each other and spaced from each other, each outer side surface extending from the top surface and the front surface; and
iv. at least one wear plate removably attached to the front surface.

10. A method of servicing a refuse incinerator grate system having modular grate blocks with removable wear plates comprising:
a) shutting down the incinerator;
b) inspecting the grate block system and identifying individual grate blocks with worn wear plates; and
c) replacing worn wear plates with new wear plates without removing individual grate blocks from the grate system.
